(19) United States
(12) Patent Application Publication
(10) Pub. No.: US 2006/0147105 A1
(43) Pub. Date: Jul. 6, 2006

(54) Alignment template goodness qualification method

(76) Inventors: Shih-Jong J. Lee, Bellevue, WA (US); Yuhui Y.C. Cheng, Redmond, WA (US); Seho Oh, Bellevue, WA (US); Shinichi Nakajima, Tokyo (JP); Yuji Kokumai, Ageo (JP)

Correspondence Address: SHIH-JONG J. LEE, 15418 SE 53RD PLACE, BELLEVUE, WA, 98006, US

(21) Appl. No.: 11/035,867

(22) Filed: Jan. 5, 2005

(51) Int. Cl. G06K 9/00

(52) U.S. Cl. 382/151

(57) ABSTRACT

An alignment template goodness qualification method receives a pattern image and a pattern based alignment template and performs template goodness measurement using the pattern image and the pattern based alignment template to generate template goodness result output. A template qualification is performed using the template goodness result to generate template qualification result output. If the template qualification result is acceptable, the pattern based alignment template is outputted as the qualified pattern based alignment template. Otherwise, an alternative template selection is performed using the pattern image, the pattern based alignment template and the template goodness result to generate alternative pattern based alignment template output. The template goodness measurements include signal content measurement, spatial discrimination measurement and pattern ambiguity measurement.

### TECHNICAL FIELD

This invention relates to the qualification of the template patterns for the automated alignment of objects. The patterns for alignment match are the design structures of the objects rather than pre-defined fiducial marks.

### BACKGROUND OF THE INVENTION

Many industrial applications such as electronic assembly and semiconductor manufacturing processes require automatic alignment of objects such as electronic components, printed circuit board or wafers. Most of the prior-art approaches use predefined fiducial marks for alignment. This requires the design and make of the marks on the objects being aligned. This process limits the flexibility of the alignment options and increases system complexity and cost because the marks have to be made on each objects. The mark making process is challenging when fine alignment is required since the variations of the created marks without rigorous control may exceed the required fine precision.

On the other hand, the inherent design patterns of the objects contain structures that could uniquely define the position of the objects and they exist on all objects to be aligned. The fineness of the design patterns naturally matches the alignment accuracy requirement because fine patterns require fine alignment and coarse patterns only require coarse alignment. Therefore, the mark making challenge can be avoided if the design patterns of the object are used as templates directly for alignment purpose without specific design and make of fiducial marks. This removes the extra steps so it could lower the cost and increase the alignment flexibility and accuracy.

The images of design patterns of an object such as circuit board or a region of a wafer could be easily acquired by a camera or other sensors. However, the images could include any customer designed patterns and not all design pattern structures are adequate for alignment. A good alignment template should have unique pattern structures in the alignment coverage region to assure that it will not be confused with other pattern structures within the same region. It also needs to have stable and easily detectable features so that the search algorithm will not miss the correct template location even if the contrast of the pattern image varies. The selection for good templates is challenging regardless whether it is performed manually or by computer automatic selection.

To achieve efficient search, one prior art approaches use multi-resolution templates. A prior art fast multi-resolution automatic template generation and search method is disclosed in Oh and Lee, “Automatic template generation and searching method”, U.S. Pat. No. 6,603,882, Aug. 5, 2003. It generates a multi-resolution template from the input image. The pattern search uses lower resolution results to guide higher resolution search. Wide search ranges are applied only at the lower resolution images and fine-tuning search are performed at higher resolution images. Another prior art approach for efficiently generating templates from design structures by pattern partition and integration is disclosed in Seho Oh, Shih-Jong James Lee, Shinichi Nakajima, Yuji Kokumai, “Partition pattern match and integration method for alignment”, U.S. patent application Ser. No. 10/961,663, Oct. 8, 2004, which is incorporated in its entirety herein.

The automatically generated templates could include a whole image region or decompose a template into a plurality of components as disclosed in Oh and Lee, “Fast invariant matching using template decomposition and synthesis”, U.S. patent application Ser. No. 10/419,913, Apr. 16, 2003. This method decomposes the template into multiple components and performs search by synthesizing the component results.

The focus of the prior art automatic template generation methods is in the fast template generation and efficient pattern search. The resulting templates could support efficient pattern search either from coarse resolution to fine resolution and/or from early components to later components. However, the prior art efficient templates may not contain high quality patterns for good spatial discrimination and variation immunity. The pattern search accuracy and repeatability could be improved if the template quality is improved.

### Objects and Advantages

This invention resolves the template quality problem by performing alignment template goodness measurement and qualification for manually selected or automatically generated alignment template(s). The alignment template goodness qualification method of this invention performs measurement and qualification of the signal content, spatial discrimination, and pattern ambiguity of the alignment template(s). If the selected template(s) cannot be qualified, alternative templates could be selected either automatically or manually.

The primary objective of this invention is to qualify the selected template for good alignment outcome. The second objective of this invention is to allow the selection of alternative templates for better alignment outcome. The third objective of the invention is to select good templates to achieve best spatial discrimination. The fourth objective of the invention is to select templates containing good signal content for stable and accurate search result. The fifth objective of the invention is to select good templates with unambiguous patterns for stable and accurate search result. The sixth objective of the invention is to provide quantitative scoring for template signal content. The seventh objective of the invention is to provide quantitative scoring for template spatial discrimination power. The eighth objective of the invention is to provide quantitative scoring for template pattern ambiguity.

### SUMMARY OF THE INVENTION

An alignment template goodness qualification method receives a pattern image and a pattern based alignment template and performs template goodness measurement using the pattern image and the pattern based alignment template to generate template goodness result output. A template qualification is performed using the template goodness result to generate template qualification result output.

If the template qualification result is acceptable, the pattern based alignment template is outputted as the qualified pattern based alignment template. Otherwise, an alternative template selection is performed using the pattern image, the pattern based alignment template and the template goodness result to generate alternative pattern based alignment template output.

The template goodness measurements include signal content measurement, spatial discrimination measurement and pattern ambiguity measurement.

### BRIEF DESCRIPTION OF THE DRAWINGS

The preferred embodiment and other aspects of the invention will become apparent from the following detailed description of the invention when read in conjunction with the accompanying drawings, which are provided for the purpose of describing embodiments of the invention and not for limiting same, in which:

FIG. 1 shows the processing flow for the alignment template goodness qualification application scenario;

FIG. 2 shows the processing flow for the template goodness measurement method;

FIG. 3A illustrates an example input image gray scale profile;

FIG. 3B illustrates the closing and opening results of the example input image gray scale profile;

FIG. 3C illustrates the closing residue result of the example input image gray scale profile;

FIG. 3D illustrates the opening residue result of the example input image gray scale profile;

FIG. 3E illustrates the contrast, closing minuses opening, result of the example input image gray scale profile;

FIG. 4A illustrates vertical signal measurement divides a template component region into top and bottom halves (T and B);

FIG. 4B illustrates horizontal signal measurement divides a template component region into left and right halves (L and R);

FIG. 5A shows an example of good (unambiguous) templates;

FIG. 5B shows the second example of good (unambiguous) templates;

FIG. 5C shows the third example of good (unambiguous) templates;

FIG. 5D shows the fourth example of good (unambiguous) templates;

FIG. 5E shows an example of bad (ambiguous) templates;

FIG. 5F shows the second example of bad (ambiguous) templates;

FIG. 5G shows the third example of bad (ambiguous) templates;

FIG. 5H shows the fourth example of bad (ambiguous) templates.

### DETAILED DESCRIPTION OF THE INVENTION

I. Application Scenario

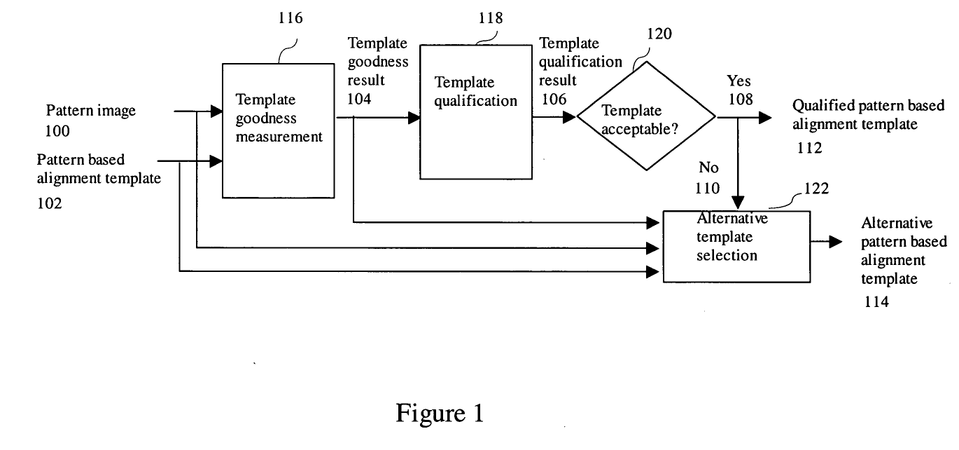

FIG. 1 shows the processing flow for the alignment template goodness qualification application scenario in one embodiment of the invention. As shown in FIG. 1, a pattern image 100 and pattern based alignment template 102 are inputted to a template goodness measurement stage 116. The template goodness measurement stage 116 processes the pattern image 100 and the pattern based alignment template 102 to generate a template goodness result 104 output. The template goodness result 104 is processed by a template qualification stage 118 that uses the template goodness result 104 to qualify the template and generates a template qualification result 106 output. If the template qualification result is acceptable 120 (‘Yes’ status 108), the pattern based alignment template 102 is outputted as the qualified pattern based alignment template 112. Otherwise, if the template qualification result is unacceptable,120 (‘No’ status 110), an alternative template selection stage 122 can be invoked that uses the pattern image 100 and the pattern based alignment template 102 as well as the template goodness result 104 to generate alternative pattern based alignment template 114 output. In one embodiment of the invention, the alternative template selection method selects the template having the highest template goodness result as the alternative pattern based alignment template.

II. Template Goodness Measurement

The template goodness measurement 116 method inputs a pattern image 100 and a pattern based alignment template 102. It uses the input data to generate at least one or a plurality of template goodness results 104. In one embodiment of the invention, a spatial discrimination measurement is included in the template goodness measurement to generate at least one spatial discrimination score for the template goodness result. In another embodiment of the invention, a pattern ambiguity measurement is included in the template goodness measurement to generate at least one pattern ambiguity score for the template goodness result. In yet another embodiment of the invention, a signal content measurement is included in the template goodness measurement to generate at least one signal score for the template goodness results. Those skilled in the art should recognize that different measurements could be combined to yield comprehensive template goodness results.

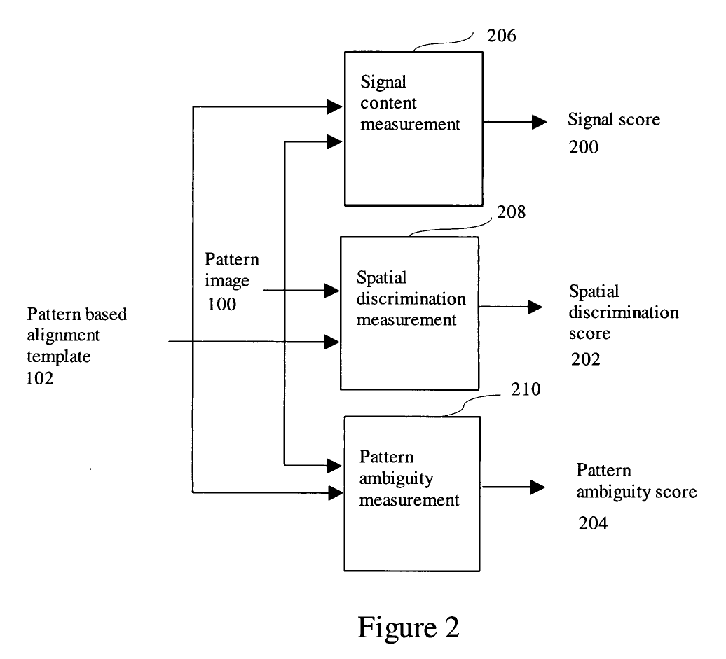

FIG. 2 shows the processing flow for the template goodness measurement method that includes all three measurement methods. As shown in FIG. 2, the signal content measurement 206 method inputs the pattern image 100 and the pattern based alignment template 102 and generates at least one signal score 200 output. The spatial discrimination measurement 208 method inputs the pattern image 100 and the pattern based alignment template 102 and generates at least one spatial discrimination score 202 output. In addition, the pattern ambiguity measurement 210 method inputs the pattern image 100 and the pattern based alignment template 102 and generates at least one pattern ambiguity score 204 output. The detailed embodiment of the signal content measurement 206 method, the spatial discrimination measurement 208 method, and the pattern ambiguity measurement 210 method are described in the following sections of this specification.

II.1 Signal Content Measurement

Given a pattern image 100 and a pattern based alignment template 102, two signal scores are generated in one embodiment of the invention. The two signal scores include a region signal score that calculates the signal content for the template generation region and a template signal score that calculates the signal content for the selected template region. Those skilled in the art should recognize that one or both signal scores could be measured depending on the complexity of an application.

A. Region Signal Content Measurement

The region signal content measurement calculates the signal score for the signal measurement region. In one embodiment of the invention, template generation region is used for signal measurement region. The template generation region is the region that is available for the template(s) to be selected. In one embodiment of the invention, the template generation region is the pattern image 100. In another embodiment of the invention, the template generation region is the region that is expanded from the template region. The expansion could be performed by morphological dilation of the template region mask.

Given a signal measurement region (such as the template generation region), I_r, its region signal score (region signal content measurement) is derived from the image pattern structure features contained in the region. In one embodiment of the invention, the image structure features are enhanced using the structure guided image feature enhancement method disclosed in Shih-Jong J. Lee, “Structure-guided image processing and image feature enhancement”, U.S. Pat. No. 6,463,175, October, 2002. The structure-guided image feature enhancement method uses two-dimensional, full grayscale processing and can be implemented efficiently and cost-effectively. The processing is nonlinear and therefore does not introduce phase shift and/or blurry effect. In one embodiment of invention the relevant structure features used including bright edge, dark edge, bright line or region, dark line or region and region contrast.

Bright Edge Enhancement:

Bright edges can be enhanced by a grayscale erosion residue processing sequence defined by:
I-IΘA

Where I is an input image and A is a structuring element and Θ is the grayscale morphological erosion operation.

Dark Edge Enhancement:

Dark edges can be enhanced by a grayscale dilation residue processing sequence defined by:
I⊕A-I

Where ⊕0 is the grayscale morphological dilation operation.

Bright Line or Region Enhancement:

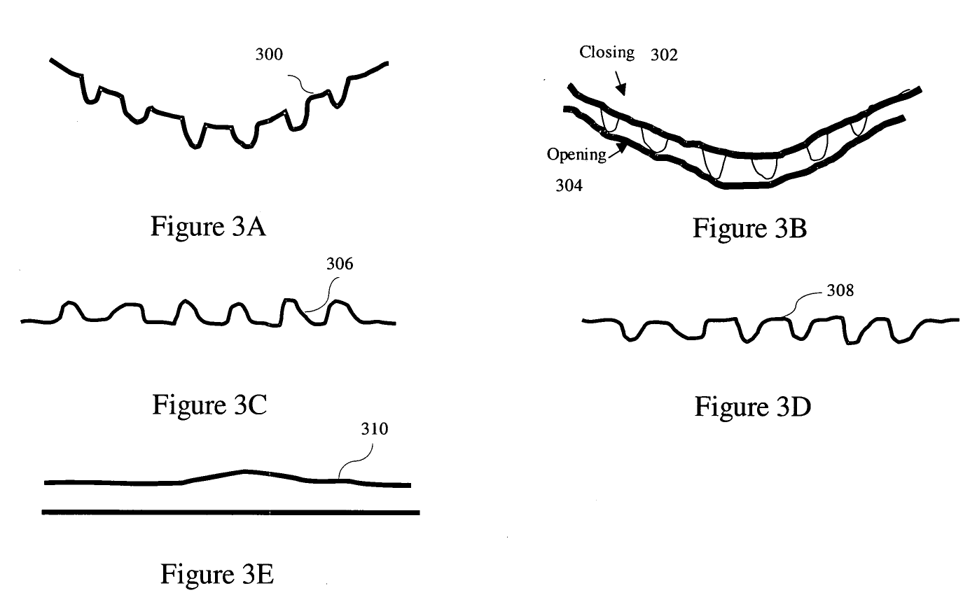

Bright line or region can be enhanced by a grayscale opening residue processing sequence defined by:
I-IOA

Where O is the grayscale morphological opening operation. FIG. 3A-FIG. 3E illustrate grayscale opening residue operation applies to a one dimensional image profile 300 as shown in FIG. 3A. FIG. 3B shows the opening result 304 of image I by a sufficiently large structuring element. The opening residue result 308 is shown in FIG. 3D. As can be seen in FIG. 3D, grayscale morphological line or region enhancement does not introduce undesired phase shift or blurry effect.

Dark Line or Region Enhancement:

Dark line or region can be enhanced by a grayscale closing residue processing sequence defined by:
I●A-I

Where ● is the grayscale morphological closing operation. FIG. 3C illustrates grayscale closing residue applies to the one dimensional image profile as shown in FIG. 3A. FIG. 3B shows the closing result 302 of image I. The closing residue result 306 is shown in FIG. 3C.

Region Contrast Enhancement:

Region contrast can be enhanced by the difference of grayscale closing and opening. The processing sequence is defined by:
I●A-IOA

FIG. 3E illustrates the difference of grayscale closing and opening applies to the illustrative one dimensional image profile 300 as shown in FIG. 3A. FIG. 3B shows the closing 302 and opening 304 results of image I 300. The difference of grayscale closing and opening 310 is shown in FIG. 3E.

In one embodiment of the invention, the proportion of the signal pixels within the signal measurement region is calculated as the signal score. That is,

$$Signal\_score = \frac{{\sum }_{( x , y ) ∈ I\_r}^{} Signal ( x , y )}{{\sum }_{( x , y ) ∈ I\_r}^{} 1}$$

The structure features are enhanced for the pixels in the signal measurement region. The structure for enhancement could be edge, line or region, contrast, or other linear or nonlinear processing to highlight structures of the region. In one embodiment of the invention, the signal pixels are the pixels within the signal measurement region whose enhanced structure feature values are higher than a threshold, T_h. That is,
Signal(x,y)=1 if F(x,y)>T_{—}h. Otherwise, Signal(x,y)=0.

The threshold value, T_h, could be determined as a function of μ_f, the average value of the structure feature enhanced values within the signal measurement region. In one embodiment of the invention, the T_h is calculated as:
T_{—}h=K*μ_{—}f where K>1.0 or
T_{—}h=μf+H where H is either a fixed value a function of the feature value distribution (such as the standard deviation).

In another embodiment of the invention, the signal score is derived from the feature enhancement region statistics. It can be determined as the value corresponding to a certain percentile of the feature enhancement region pixels. That is,
Signal_score=enhance_{—}p(I_{—}r).

Where enhance_p(I_r) is the p percentile value of the feature enhanced pixel values in region I_r. The feature enhancement could be the edge enhancement, line or region enhancement, contrast enhancement, or other linear or nonlinear processing to highlight structures of the region

In yet another embodiment of the invention, the signal score is derived from a combination of the statistics derived from coarse and fine feature enhancements of the region. In this embodiment of the invention, the formula for signal score calculation is as follows:
Signal score=MIN(Fine_{—}80%, Coarse_{—}99%/3.0).

Where Coarse_{—}99% is the 99 percentile (close to maximum) pixel value of the I_coarse_enhance and Fine_{—}80% is the 80 percentile pixel value of the I_fine_enhance. The I_coarse_enhance is the coarse feature enhanced signal measurement region. The I_fine_enhance is the fine feature enhanced signal measurement region. The coarse feature enhancement uses larger structuring element than the coarse feature enhancement. In one embodiment of the invention, the contrast feature is used for the enhancement and the contrast enhancement is performed as follows:
I_coarse_enhance=I_{—}r●9×9−I_{—}r O 9×9
I_fine_enhance=(I_{—}r*5×5−I_{—}r O 5×5)⊕5×5

Where

9×9 designates a flat top morphological structuring element of size 9 pixels by 9 pixels;

5×5 designates a flat top morphological structuring element of size 5 pixels by 5 pixels.

Those skilled in the art should recognize that other feature enhancement methods such as the edge enhancement, line or region enhancement, or other linear or nonlinear processing to highlight structures of the region can be similarly applied. Also, the size s of the structuring elements and the percentiles (99% and 80%) used could be changed. In addition, the weighting factor (1/3.0) could also be changed.

B. Template Signal Content Measurement

The template signal content measurement calculates the signal score for a template region. In one embodiment of the invention, at least one directional signal is calculated. The direction can be vertical, horizontal, diagonal, or any given arbitrary directions. The directional signal is measured using directional projection and signal range derivation method. The scores for vertical and horizontal signals are described in this section. The vertical signal score measures the vertical structure signal content within the template region. The horizontal signal score measures the horizontal structure signal content within the template region. Those skilled in the art should recognize that the scope of the invention should cover any directions rather than limited to vertical and horizontal directions.

Vertical Signal Score

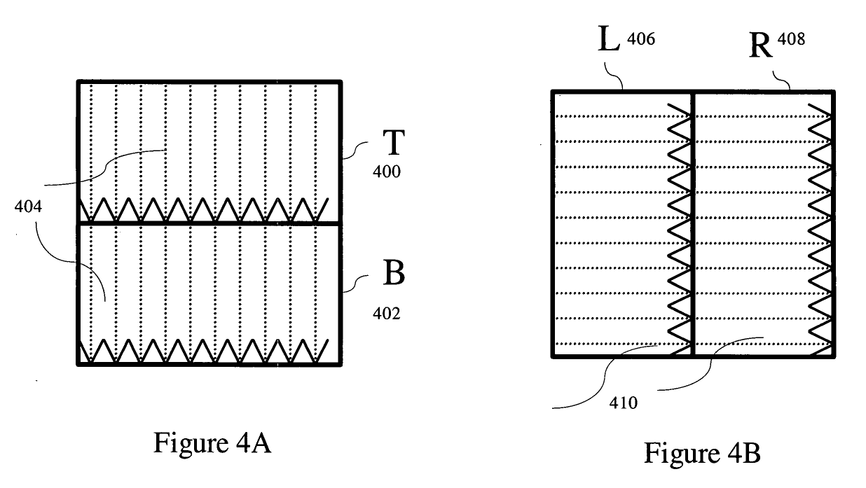

In one embodiment of the invention, given a template component C having width W and height H, its vertical signal score, Vertical_signal_C, can be calculated by the following procedures:
(1) Divide the region of C into top and bottom halves (T 400 and B 402). The two halves could have zero or non-zero pixel overlap between them (see FIG. 4A).
(2) Perform horizontal projection by accumulating the pixel values vertically 404 for the T 400 and B 402 regions separately. This results in T and B horizontal projection arrays for C. That is,
   Horizontal_projection_{—}T_{—}C[k] where kε[1,W].
   Horizontal_projection_{—}B_{—}Ci[k] where kε[1,W].
(3) Derive the vertical signal scores for the top and bottom halves from the signal range measurements as follows:
   Vertical_signal_{—}T_{—}C=MAX(H_{—}T_{—}C_max−H_{—}T_{—}C_median, H_{—}T_{—}C_median−H_{—}T_{—}C_min)
   Vertical_signal_{—}B_{—}C=MAX(H_{—}B_{—}C_max−H_{—}B_{—}C_median, H_{—}B_{—}C_median−H_{—}B_{—}C_min)
Where
H_T_C_max is the maximum value among Horizontal_projection_T_C[k]
H_T_C_median is the median value of Horizontal_projection_T_C[k]
H_T_C_min is the minimum value among Horizontal_projection_T_C[k]
H_B_C_max is the maximum value among Horizontal_projection_B_C[k]
H_B_C_median is the median value of Horizontal_projection_B_C[k]
H_B_C_min is the minimum value among Horizontal_projection_B_C[k]

Those skilled in the art should recognize that maximum value could be replaced by an upper percentile value; minimum value could be replaced by a lower percentile value; median value could be replaced by other data center estimator (such as mean) for the signal range and signal score calculations. Also, the region can be divided into one, three or more sub-regions rather than two halves for projection and signal range deviation measurement.
(4) Determine the vertical signal score for the template component C by
   Vertical_signal_{—}C=Max(Vertical_signal_{—}T_{—}C, Vertical_signal_{—}B_{—}C)

Those skilled in the art should recognize that the combination of Vertical_signal_T_C and Vertical_signal_B_C to create Vertical_signal_C, could be done by other means such as linear combination or multiplication, etc.

Horizontal Signal Score

Similarly, in one embodiment of the invention, given a template component C having width W and height H, its horizontal signal score, Horizontal_signal_C, can be calculated by the following procedures:
(1) Divide the C region into left and right halves (L 406 and R 408). The two halves could have zero or non-zero pixel overlap between them (see FIG. 4B).
(2) Perform vertical projection by accumulating the pixel values horizontally 410 for the L 406 and R 408 regions separately. This results in L and R vertical projection arrays for C. That is,
   Vertical_projection_L_C[k] where kε[1,H].
   Vertical_projection_R_C[k] where kε[1,H].
(3) Derive the horizontal signal scores for the left and right halves from the signal range measurements as follows
   Horizontal_signal_{—}L_{—}C=MAX(V_{—}L_{—}C_max−V_{—}L_{—}C_median, V_{—}L_{—}C_median−V_{—}L_{—}C_min)
   Horizontal_signal_{—}R_{—}C=MAX(V_{—}R_{—}C_max−V_{—}R_C_median, V_{—}R_{—}C_median−V_{—}R_{—}C_min)
Where
V_L_C_max is the maximum value among Vertical_projection_L_C[k]
V_L_C_median is the median value of Vertical_projection_L_C[k]
V_L_C_min is the minimum value among Vertical_projection_L_C[k]
V_R_C_max is the maximum value among Vertical_projection_R_C[k]
V_R_C_median is the median value of Vertical_projection_R_C[k]
V_R_C_min is the minimum value among Vertical_projection_R_C[k]

Those skilled in the art should recognize that maximum value could be replaced by an upper percentile value; minimum value could be replaced by a lower percentile value; median value could be replaced by other data center estimator (such as mean) for the signal range and signal score calculations. Also, the region can be divided into one, three or more sub-regions rather than two halves for projection and signal range deviation measurement.
(4) Determine the horizontal signal score for the template component C by
   Horizontal_signal_{—}C=Max(Horizontal_signal_{—}L_{—}C, Horizontal_signal_{—}R_{—}C)

Those skilled in the art should recognize that the combination of Horizontal_signal_L_C and Horizontal_signal_R_C to create Horizontal_signal_C, could be done by other means such as linear combination or multiplication, etc.

II.2 Spatial Discrimination Measurement

Given a pattern image and a pattern based alignment template the spatial discrimination measurement method measures the spatial discrimination scores. A good alignment template should be able to uniquely define a matching position for alignment.

In the case that the template has only one component (region), the spatial discrimination (unique position) has to be achieved within the component. In the case that a plurality of template components exist, the spatial discrimination could be achieved by the combination of the plurality of template components. For example, one component could provide a unique X position and the other component could provide a unique Y position.

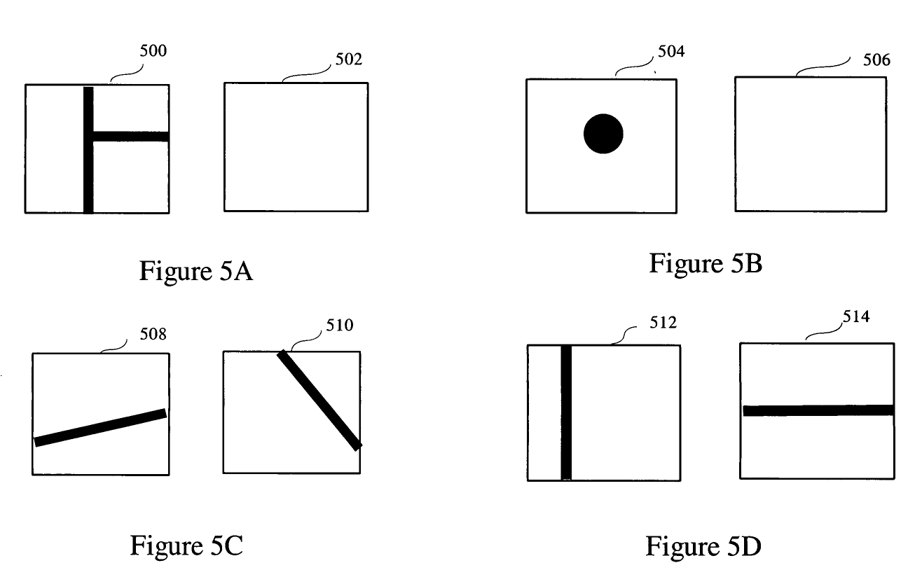

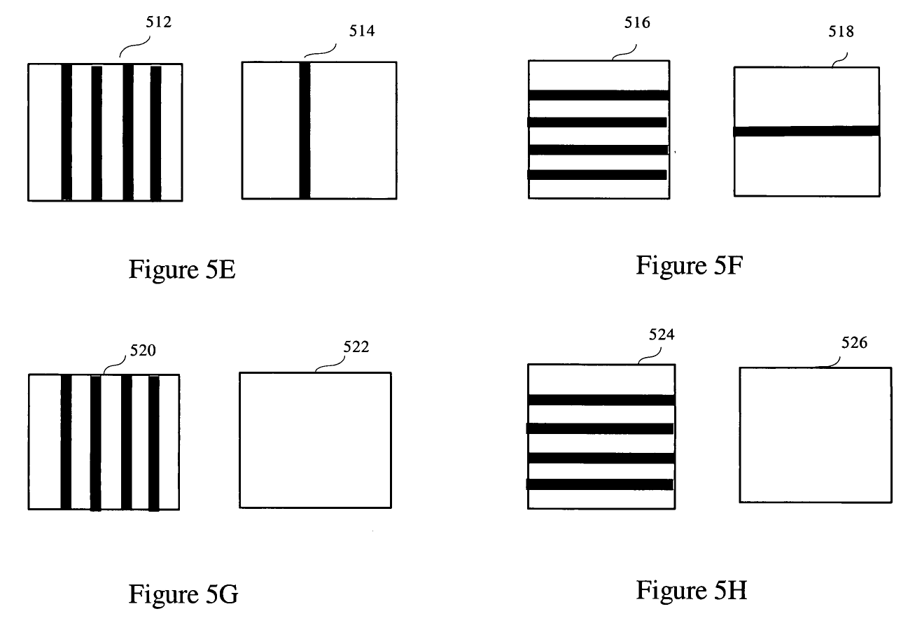

The spatial discrimination measurement for a two component template is illustrated in FIG. 5A-FIG. 5H. Those skilled in the art should recognize that the scope of the invention should cover any non-zero number of template components rather than limited to two components. When the template contains two components, it is required that the two template components can define an unambiguous (X, Y) position. This means that there must be at least one pattern in one of the template components that could define X position unambiguously AND at least one pattern in one of the template components could define Y position unambiguously.

FIG. 5A-FIG. 5H shows some examples of good (unambiguous) and bad (ambiguous) two component templates. The spatial discrimination measurement should account for the combining effect of the two template components. This allows one of the template component to be blank, if the other template component already has structures to define both X, Y positions (500 and 502 in FIG. 5A, 504 and 506 in FIG. 5B, 508 and 510 in FIG. 5C, 512 and 514 in FIG. 5D). On the other hand, a template spatial discrimination could be considered no good even if either one or both template components have strong structure signals but for only one (but not both) of X or Y positions (512 and 514 in FIG. 5E, 516 and 518 in FIG. 5F, 520 and 522 in FIG. 5G, 524 and 526 in FIG. 5H).

In one embodiment of the invention, the spatial discrimination score is derived from combinations of at least two directional signal scores (such as the vertical and horizontal signal scores) and the region signal score of the template generation region.

II.2.1 Raw Discrimination Score

The template (combination of all components) vertical signal score is defined as the maximum vertical signal score between its component Cᵢ where i≧1 as follows:

$$Vertical\_signal = {MAX}_{i} ( Vertical\_signal {\_C}_{i} ) .$$

Similarly, the template horizontal signal score is defined as the maximum horizontal signal score between its component Cᵢ where i≧1 as follows:

$$Horizontal\_signal = {MAX}_{i} ( Horizontal\_signal {\_C}_{i} ) .$$

The raw discrimination score is defined as the minimum of Vertical_signal and Horizontal_signal:
Raw_discrimination=MIN(Vertical_signal, Horizontal_signal)

That is, the raw discrimination score of a template is the worst of its template vertical signal score and template horizontal signal score. This enforces the requirement that a good template discrimination needs to have good signals in both vertical and horizontal directions.

II.2.2 Component Discrimination Score

The discrimination score could be determined for each component Cᵢ of the template as follows:
Discrimination_{—}Cᵢ=MIN(Vertical_signal_{—}Cᵢ, Horizontal_signal_{—}Cᵢ)
where i≧1.

An integrated component discrimination score can be defined as follows:

$$Integrated\_component \_discrimination = {\sum }_{i} {α}_{i} * {Discrimination\_C}_{i}$$

Even though Discrimination_Cᵢ is less than or equal to Raw_discrimination, the Integrated_component_discrimination could be greater than Raw_discrimination if the summation of the integration factor αᵢ for all i is greater than 1.0. The Integrated_component_discrimination has a higher value than Raw_discrimination when many of the Discrimination_Cᵢ have high values. That is, many components have good patterns to define both X and Y positions.

II.2.3 Spatial Discrimination Score

In one embodiment of the invention, a combined discrimination score, Combined_discrimination, is defined as:
Combined_discrimination=MAX(Raw_discrimination, Integrated_component_discrimination).

A normalized combined discrimination score, Normalized_combined_discrimination, that normalizes the combined discrimination score by the-region signal score is defined as:
Normalized_combined_discrimination=Combined_discrimination/Signal_score

Finally, the spatial discrimination score, spatial_discrimination_score, is defined as a function of the Combined_discrimination and the Normalized_combined_discrimination. In one embodiment of the invention, a quadratic combination is used:
Spatial_discrimination_score=K₁*(Combined_discrimination)²+K₂*(Normalized_combined_discrimination)²

Where K₁ and K₂ are the weighting factor for the quadratic combination.

Those skilled in the art should recognize that other method of combination such as linear, polynomial, geometric mean, etc. Furthermore, the Combined_discrimination or Normalized_combined_discrimination can be used as the Spatial_discrimination_score without the combination.

The Spatial_discrimination_score is the summary score for the spatial discrimination power of the template. Higher Spatial_discrimination_score value corresponds to better template spatial discrimination power.

Those skilled in the art should recognize that even though the spatial discrimination score is derived from measurements of signals in the horizontal and vertical directions only. The signals of other directions can also be used for the spatial discrimination score. Furthermore, the spatial discrimination score can be performed for single component template or for templates with two or more components.

II.3 Pattern Ambiguity Measurement

Given a pattern image and a pattern based alignment template, the pattern ambiguity measurement measures the ambiguity of the template patterns around the neighbor of the template.

In one embodiment of the invention, the pattern ambiguity score is calculated as
Pattern ambiguity score=M1/M

Where M is the auto-matching value of the template region and M₁ is the maximum matching value between the template and the image pixels within the ambiguity check region, which is the neighbor of the template. The neighbor can be determined by dilating the template region by a structuring element of a desired neighboring size. The matching value can be determined by the normalized correlation (Ballard D H and Brown C M, “Computer Vision”, Prentice-Hall Inc. 1982 pp. 68-70). Other matching methods could also be used such as absolute difference, simple image multiplication, etc.

III. Template Qualification

The template qualification method checks the template goodness results to determine whether the template is acceptable or not. In one embodiment of the invention, the template qualification performs signal content qualification check that rejects a template if its signal score is less than a threshold. In another embodiment of the invention, the template qualification performs spatial discrimination qualification check that rejects a template if its spatial discrimination score is less than a threshold. In yet another embodiment of the invention, the template qualification performs pattern ambiguity qualification check that rejects a template if its pattern ambiguity score is greater than a threshold.

The template qualification can also be applied to a plurality of the scores simultaneously by combining the scores. In one embodiment of the invention, a weighted linear combination is applied to the signal score, spatial discrimination score, and the inverse of the pattern ambiguity score to generate an integrated score. The weighting factors for the scores normalize the scores into similar ranges and account for the individual variations of the scores. A threshold can be applied to the integrated score. A template is rejected if its integrated score is less than a threshold.

Those skilled in the art should recognize that other methods of the score combination such as polynomial combination, multiplication, logarithm, square root, or other nonlinear combination can also be used.

The invention has been described herein in considerable detail in order to comply with the Patent Statutes and to provide those skilled in the art with the information needed to apply the novel principles and to construct and use such specialized components as are required. However, it is to be understood that the inventions can be carried out by specifically different equipment and devices, and that various modifications, both as to the equipment details and operating procedures, can be accomplished without departing from the scope of the invention itself.

What is claimed is:

1. An alignment template goodness qualification method comprising the steps of:
a) Input a pattern image;
b) Input a pattern based alignment template;
c) Perform template goodness measurement using the pattern image and the pattern based alignment template having template goodness result output;
d) Perform template qualification using the template goodness result having template qualification result output.

2. The method of claim 1 outputs pattern based alignment template as the qualified pattern based alignment template if the template qualification result is acceptable.

3. The method of claim 1 further comprises an alternative template selection stage using the pattern image, the pattern based alignment template and the template goodness result to generate alternative pattern based alignment template output if the template qualification result is unacceptable.

4. The method of claim 1 wherein the template goodness measurement method performs measurement selected from the set consisting of
a) Signal content measurement,
b) Spatial discrimination measurement,
c) Pattern ambiguity measurement.

5. An alignment template goodness measurement method comprising the steps of:
a) Input a pattern image;
b) Input a pattern based alignment template;
c) Perform template goodness measurement selected from the set consisting of
a. Signal content measurement,
b. Spatial discrimination measurement,
c. Pattern ambiguity measurement.

6. The method of claim 5 wherein the signal content measurement uses the pattern image and the pattern based alignment template to generate at least one signal score output.

7. The method of claim 5 wherein the spatial discrimination measurement uses the pattern image and the pattern based alignment template to generate at least one spatial discrimination score output.

8. The method of claim 5 wherein the pattern ambiguity measurement uses the pattern image and the pattern based alignment template to generate at least one pattern ambiguity score output.

9. The method of claim 6 wherein the signal score selects from the set consisting of:
a) Region signal score,
b) Template signal score.

10. The method of claim 7 wherein the spatial discrimination measurement further generates at least one raw discrimination score and at least one component discrimination score.

11. An alignment signal content measurement method comprising the steps of:
a) Input a pattern image;
b) Input a pattern based alignment template;
c) Perform region signal content measurement using the pattern image and the pattern based alignment template having at least one region signal score output;
d) Perform template signal content measurement using the pattern image and the pattern based alignment template having at least one template signal score output.

12. The method of claim 11 wherein the region signal content measurement performs structure-guided image feature enhancement selected from the feature set consisting of:
a) Bright edge,
b) Dark edge,
c) Bright line or region,
d) Dark line or region,
e) Region contrast.

13. The method of claim 11 wherein the region signal score is the proportion of the signal pixels within the signal measurement region.

14. The method of claim 11 wherein the region signal score is the value corresponding to a percentile of the feature enhancement region pixels.

15. The method of claim 11 wherein the region signal score is derived from a combination of the statistics derived from coarse and fine feature enhancements.

16. The method of claim 11 wherein the template signal content measurement calculates at least one directional signal.

17. The method of claim 16 wherein the directional signal is measured using directional projection and signal range derivation method.

18. An alignment template spatial discrimination measurement method comprising the steps of:
a) Input a pattern image;
b) Input a pattern based alignment template;
c) Perform signal content measurement using the pattern image and the pattern based alignment template to generate a plurality of directional signal scores output;
d) Perform spatial discrimination measurement using the plurality of directional signal scores having at least one spatial discrimination score output.

19. The method of claim 18 wherein the spatial discrimination score includes a raw discrimination score combining the template vertical signal score and template horizontal signal score.

20. The method of claim 18 wherein the spatial discrimination score includes a component discrimination score combining the vertical signal score and horizontal signal score of a component.

21. The method of claim 18 wherein the spatial discrimination score includes an integrated component discrimination score.

22. The method of claim 18 wherein the spatial discrimination score includes a combined discrimination score.

23. The method of claim 22 wherein combined discrimination score is normalized to generate a normalized combined discrimination score.

24. The method of claim 23 wherein the combined discrimination score and the normalized combined discrimination score are used to generate a spatial discrimination score.

25. An alignment template pattern ambiguity measurement method comprising the steps of:
a) Input a pattern image;
b) Input a pattern based alignment template;
c) Perform auto-matching of the template region having an auto-matching value output;
d) Perform matching between the template and the image pixels within the neighbor of the template having a maximum matching value output.
e) Divide the maximum matching value by the auto-matching value as the pattern ambiguity score output.

26. An alignment template goodness qualification method comprising the steps of:
a) Input a pattern image;
b) Input a pattern based alignment template;
c) Perform template qualification using the pattern image and the pattern based alignment template and select from the set consisting of:
a. Signal content measurement and qualification check;
b. Spatial discrimination measurement and qualification check;
c. Pattern ambiguity measurement and qualification check.

27. The alignment template goodness qualification method of claim 26 wherein the qualification check applies a threshold.

28. The alignment template goodness qualification method of claim 26 wherein the qualification check applies to an integrated score.
